(19) United States
(12) Patent Application Publication
(10) Pub. No.: US 2014/0272561 A1
(43) Pub. Date: Sep. 18, 2014

(54) Alternative Current Collectors for Thin Film Batteries and Method for Making the Same

(71) Applicant: Apple Inc., Cupertino, CA (US)

(72) Inventors: Lili Huang, San Jose, CA (US); Richard M. Mank, Cupertino, CA (US); Seung Jae Hong, Sunnyvale, CA (US)

(73) Assignee: Apple Inc., Cupertino, CA (US)

(21) Appl. No.: 14/041,059

(22) Filed: Sep. 30, 2013

Related U.S. Application Data
(60) Provisional application No. 61/781,811, filed on Mar. 14, 2013.

(51) Int. Cl. H01M 4/74; H01M 4/139; H01M 4/04

(52) U.S. Cl. CPC H01M 4/74; H01M 4/0433; H01M 4/0471; H01M 4/139; H01M 4/0404
USPC 429/211; 427/58; 216/13; 427/532; 427/123; 156/272.8; 427/554

(57) ABSTRACT

A thin film battery has one or more current collectors with a substantially mesh configuration. The mesh current collector may include a network or web of thin strands of current collector material. The thin strands may overlap each other and/or may be arranged to define a plurality of individual cells within the mesh current collector. The strands of the mesh current collector may also be arranged to have a grid-like configuration. Additionally, in some configurations, the anode or cathode may fill the cells within the current collector layer to optimize the amount of active material within the battery.

### CROSS-REFERENCE TO RELATED APPLICATION

This application claims the benefit under 35 U.S.C. §119(e) to U.S. Provisional Patent Application No. 61/781,811, filed Mar. 14, 2013, entitled “Alternative Current Collectors for Thin Film Batteries and Method for Making the Same,” the entirety of which is incorporated herein by reference as if fully recited herein.

### TECHNICAL FIELD

The present invention relates generally to batteries, and more specifically to current collectors for thin film batteries.

### BACKGROUND

Many electronic devices, such as laptops, tablet computers, smartphones, and the like, use rechargeable batteries to provide power to one or more electronic components. A number of electronic devices use batteries as the power source. For example, one type of battery used is thin film batteries, which have a potential high energy density while also maintaining a relatively compact configuration.

The main disadvantages associated with thin film batteries are the high costs involved in producing the batteries (e.g., cost related to the material and manufacturing process). For example, typical thin film batteries may include active layers (e.g., anode and cathode) and non-active layers (e.g., current collectors) where the current collectors are made of a solid layer of material. Compared with the active materials (e.g., anode layer and cathode layer), having a solid current collector layer can represent a noticeable percentage of overhead costs.

As electronic devices are becoming smaller, there is an increased need for smaller batteries. Thus, there is an increased need to maximize the energy density of the batteries, such as in thin film batteries, while also maintaining a relatively compact size and keeping production of the battery economical and practical.

### SUMMARY

Some embodiments described herein include a thin film battery having current collectors with a substantially mesh configuration. The mesh current collector may include a network or web of thin strands of current collector material. The thin strands may overlap each other and/or may be arranged to define a plurality of individual cells within the mesh current collector. The strands of the mesh current collector may also be arranged to have a grid-like configuration. Additionally, in some configurations, the anode or cathode may fill the cells within the current collector layer to optimize the amount of active material within the battery.

### BRIEF DESCRIPTION OF THE DRAWINGS

FIG. 1 is a perspective view of an electronic device incorporating the thin film battery.

FIG. 2 is a view of another electronic device incorporating the thin film battery.

FIG. 3 is a cross-sectional view of the stacked layers within a battery device in a first configuration.

FIG. 4 is a simplified top view of a mesh current collector.

FIG. 5A is a view of an exemplary mesh current collector.

FIG. 5B is another view of an exemplary mesh current collector.

FIG. 5C is another view of an exemplary mesh current collector.

FIG. 6 is a cross-sectional view of the stacked layers within a battery device in second configuration.

FIG. 7 is a simplified diagram of a method of manufacturing the mesh current collector layer.

FIG. 8 is a simplified block diagram of the method of manufacturing the mesh current collector of FIG. 7.

FIG. 9 is a simplified diagram of a method of manufacturing the mesh current collector.

FIG. 10 is a simplified diagram of a method of manufacturing the mesh current collector.

FIG. 11 is a simplified diagram of a method of manufacturing the mesh current collector layer.

FIG. 12 is a chart detailing materials and patterning process methods for manufacturing mesh current collectors.

### SPECIFICATION

### Overview

In some embodiments herein, a thin film battery and a method for manufacturing the battery are disclosed. The battery may include a battery core having stacked layers that may form the components of the battery. For example, in some embodiments, the stacked layers may include a substrate, cathode current collector, cathode, electrolyte, anode, and anode current collector.

The cathode and anode layers of the battery may be active or energy-density layers and the current collector may be a non-active or non-energy density related layer. The current collector may be minimized to maximize the energy density of the battery and to reduce the material overhead of the battery.

In some embodiments of the present disclosure, the current collectors can have a mesh configuration. The mesh current collector can be made of thin strands of current collector material. In some embodiments, the thin strands may be a network or web of strands. The strands may also be arranged and/or aligned to define a plurality of individual cells within the mesh current collector. The anode and/or cathode can fill the cells within the anode and/or cathode current collector, respectively, to optimize the amount of active material within the battery core.

The stacked layer within the core may be configured with the anode current collector positioned above the anode layer and/or the cathode current collector positioned below the cathode, with an electrolyte positioned between the cathode and anode layers. The mesh current collector provides for a lower stress which can result in a more stable product.

In other embodiments, the anode current collector may be positioned below the anode layer. By positioning the anode current collector below the anode layer, the anode current collector is less affected by the expansion and contraction of the anode during charge and discharge of the battery while still allowing ions to transfer through the cells or spaces within the mesh anode current collector between the anode and cathode layers.

The mesh current collector may be manufactured using traditional methods, e.g., physical vapor deposition (PVD) or e-beam evaporation, or using more inexpensive methods such as, but not limited to, electro-plating, screen printing, ink-jet printing, gravure, embossed, off-set printing, laser ablation, laser direct writing, or select deposition.

### DETAILED DESCRIPTION

Turning to the figures, an illustrative thin film battery having a mesh current collector will be discussed in further detail. FIGS. 1 and 2 are illustrative electronic devices 100, 102 incorporating one or more batteries 104 (shown in cross-section in FIG. 3). Although FIGS. 1 and 2 depict an illustrative laptop and smartphone device, it is appreciated that other devices can incorporate thin film batteries, such as, but not limited to, tablet computers, remote controls, and the like.

FIG. 3 illustrates a cross-sectional view of an exemplary battery 104 having a battery core 120 with a stacked layer configuration. The battery core 120 can have an anode layer 108, an electrolyte 110, a cathode 112, a substrate 116, and current collectors 107 (e.g., anode current collector 106 and cathode current collector layer 114). The battery 104 may further include an encapsulation 118 or housing around the battery core 120 to provide some protection and structure for the battery 104. It should be noted that although the battery 104 is illustrated in FIG. 3 as being generally rectangular, many other dimensions and shapes are envisioned, such as but not limited to, geometric, non-geometric, or the like. As one further example, multiple batteries may be stacked and enclosed within the same foil pouch or other encapsulation.

A positive terminal 122 and a negative terminal 124 may extend through the encapsulation 118, or may otherwise be configured such that the terminals 122, 124 are in communication with the battery core 120 and with one or more external components (e.g., components of the electronic devices 100, 102). The terminals 122, 124 may transfer current from the battery core 120 to one or more components of the electronic device 100, 102 and also may transfer current to the battery core 120 from an external power source (e.g., charging the battery 104).

The cathode current collector 114 may be in communication with the positive terminal 122, and the anode current collector 106 may be in communication with the negative terminal 124. The cathode current collector 114 and anode current collector 106 may be made from a material that has a high electric conductivity (low resistivity), corrosion resistant, and is stable at high temperatures (i.e., no alloy formation at high temperatures, such as at 700° C.). The cathode current collector 114 may be positioned on a substrate 116, or otherwise may form the substrate and base on which the cathode 112 can be positioned.

To maximize the potential high energy density in the battery 104, the current collectors 126 can have a substantially mesh configuration, for example, as illustrated in FIG. 4. It is noted that although FIG. 4 illustrates the mesh current collector 126 on a substrate 116, the mesh current collector 126 is not necessarily required to be positioned on a substrate 116.

A network or web of thin strands 128 of a current collector material may be arranged to form the mesh current collector 126. The mesh current collector 126 may also include a plurality of cells 130 defined by the strands 128, for example, as illustrated in FIG. 4. Each cell may comprise of an open space bounded by the strands 128. The thin strands 128 may be overlapped, interwoven, knitted, and/or interconnected with each to form the mesh current collector 126. The individual strands 128 may also be connected at connecting points 132. In some embodiments, the strands 128 can be arranged to define a generally grid-like configuration, for example, as illustrated in FIG. 4. It should be noted that although the strands 128 as illustrated in FIG. 4 are arranged to define generally square cells 130, many other dimensions and shapes are envisioned. For example, as illustrated in FIGS. 5A-5C, the strands 128 can be aligned to define cells 130 having a generally hexagonal shape (i.e., FIG. 5A), a general diamond shape (i.e., FIG. 5B), or a generally square shape having curved corners and thicker connecting points 132 (i.e., FIG. 5C). It should also be noted that the width 134 of the cell 130 (i.e., distance between individual strands 128) can also vary. For example, in some configurations, the width 134 of the cell 130 can range from, e.g., 2 microns to 4 microns.

The width and thickness of the strands 128 can vary depending on the requirement of the sheet resistance of the current collector. In some embodiments, the width and thickness of the strands 128 can be configured to be as thin as practical while still maintaining enough strength such that the strands 128 do not delaminate (such as when more charge is pushed through the layers causing the temperature of the core 120 to rise).

The width 131 of the mesh current collector 126 can range from, e.g., a few microns to tens or hundreds of microns, depending on the requirement of the sheet resistance of the current collector. The thickness of the mesh current collector 126 can range from, e.g., a sub-micron to a few microns depending on the sheet resistance required by the battery design. For example, in some configurations, the mesh current collector 126 can have a thickness ranging from a sub-micron to approximately about 3 microns.

The mesh current collector 126 can be made from any of, but is not limited to, aluminum, copper, silver, gold, nickel, titanium, stainless steel, molybdenum, tungsten, carbon nanotubes, platinum, chromium, iron, and/or alloys or combinations of the foregoing.

Compared to traditional solid current collector layers, the mesh current collector 126 described herein may decrease the overhead costs of production while also potentially enhancing the potential energy density of the battery. The mesh current collector 126 requires less material compared to a solid current collector layer. Further, the mesh current collector 106, 114 occupies a smaller fraction of the battery core 120 partly due to the cells 130 (e.g., spaces within the cells 130) between the individual strands 128. As a result, in some embodiments, portions of the active material (e.g., the anode layer 108 or cathode layer 112) can fill the space within the cells 130 of the current collector (e.g., the anode current collector 106 or cathode current collector 114) which increases the energy density of the battery 104 without increasing the size of the overall battery 104.

Having a mesh configuration 126 also provides for lower film stress which results in a more stable and reliable product. In particular, the discontinuity provided by a mesh configuration 126 (e.g., due to the cells 130 between the strands 128) may prevent the substrate 116 from bending, deforming, or even film peeling. Further, traditional substrates have a dual function in which the cathode current collector also formed the substrate (i.e. the two were coupled together) and thus, a traditional substrate had to be conductive and metal to act as both the current collector and base on which a cathode may be positioned. By decoupling the current collector and substrate (e.g., the mesh current collector 126 is separate from the substrate 116), the selection of the substrate can be widened and the substrate can be made of a non-metallic material, such as, but not limited to, a polymer.

Although the stacked configuration in FIG. 3 illustrates the anode current collector layer 106 above the anode layer 108 and the cathode current collector layer 114 below the cathode layer 112, it should be noted that other configurations and arrangements can be used. For example, in some embodiments, the anode layer 108 can be positioned above the anode current collector layer 106 as illustrated in FIG. 6. Traditionally, the anode current collector layer 106 in thin film batteries is positioned above the anode layer 108. This configuration may be problematic, however, because as the battery is recharged and discharged, the anode contracts and expands causing the traditional solid anode current collector layer to bend and eventually crack. The bent and cracked solid anode current collector layer may lead to isolated areas within the battery core in which the ions are trapped and cannot move between the anode to cathode layer. This may reduce the overall life and energy density of the battery.

By placing the mesh anode current collector 106 below the anode layer 108, the mesh anode current collector 106 is less affected by the contracting and retracting anode layer 108 as it recharges and discharges. Further, the mesh anode current collector 106 may provide for lower film stress, which also may reduce the effects of the contracting and retracting anode layer 108. Unlike traditional solid current collector layers, the cells 130 within the mesh anode current collector 106 described herein can further act as channels by which the ions can pass through between the anode layer 108 and cathode layer 112 when the anode current collector 106 placed underneath the anode layer 108.

### Methods of Manufacturing

Current collectors in thin film batteries, such as a solid layer current collector, are traditionally manufactured using physical vapor deposition (PVD) or e-beam evaporation. This process of manufacturing can be costly, and thereby increases the overall costs of manufacturing the thin film battery.

A mesh current collector 126 as described herein may be manufactured by a number of other processes including, but not limited to, electro-plating, screen printing, ink-jet printing, gravure, embossed, off-set printing, laser ablation, laser direct writing, or select deposition. Such processes may be less expensive than the traditional PVD or e-beam evaporation method of manufacturing, and thus, may significantly reduce the overall cost of manufacturing the battery 104.

The various alternative methods of manufacturing a mesh current collector 126 will now be described. In some embodiments, the mesh current collector 126 may be made through a nano-imprint process. FIGS. 7 and 8 illustrate one exemplary method of nano-imprinting that can be used. A mold 136 may be manufactured to include the desired pattern of the mesh current collector 126 (step 200 of FIG. 8). In some embodiments, the mold 136 may include protrusions 140 and recesses 142 that correspond to the position of the strands 128 and cells 130, respectively, within the mesh configuration 126. A resist material 138 can be coated on the surface of the substrate 116 (step 202 of FIG. 8). The resist material 138 may be, but not required to be, a photo resist material. The mold 136 may be pressed on the resist material 138 to mold the resist material 138 into having the desired pattern that corresponds to the desired mesh configuration (step 204 of FIG. 8). The resist material 138 may be cleaned such that recessed areas 144 within the resist material 138 expose portions of the substrate 116 surface (step 206 of FIG. 8). A current collector material 146 may be coated on the resist material 138 and on the exposed portions of the substrate 116 surface (step 208 of FIG. 8). The resist material 138 may then be removed from the substrate 116 such that only the current collector material 146 coated on the exposed portions substrate 116 surface remains (step 210 of FIG. 8). The resist material 138 may be removed from the substrate 116 by a variety of suitable processes, such as, but not limited to, interconnecting the resist material 138 and peeling it off the substrate 116, using a solvent to dissolve the resist material 138, heating the resist material 138, and in some cases depending on the resist and substrate materials used, illuminating the backside of a substrate 116.

FIG. 9 illustrates another exemplary method of nano-imprinting or embossing that may be used. Similar to the nano-imprinting process described in FIGS. 7 and 8, a mold 136 may be manufactured to include the desired pattern of the mesh configuration 126. In some embodiments, the mold 136 may include recesses 150 that correspond to position of the strands 128 within the desired mesh current collector 126. A current collector material 146 is coated directly on the substrate 116, and the mold 136 is then pressed on the current collector material 146 to produce the desired pattern of the mesh current collector 126. The metal residue may then be cleaned off the substrate 116.

Laser direct writing may also be used to manufacture the mesh current collector 126. FIG. 10 illustrates one exemplary method of laser direct writing that can be used. A transparent support 152 may have a transferable material 154, such as a current collector material, adhered to the backside of the transparent support 152 with a substrate 116 positioned directly thereunder. A pulsed UV laser 156 can be focused through a microscopic objective 158 on the transparent support 152. The pulsed UV laser 154 causes the transferable material 154 to be released from the transparent support 152 and deposited onto the substrate 116. Thus, the pulsed UVA laser 154 and microscopic objective 158 configuration can be moved along the transparent support 152 to create the desired pattern of the mesh current collector layer 126.

FIG. 11 illustrates another exemplary method of laser direct writing that can be used. A current collector material 162 such as, but not limited to, silver ion (Ag+), can be coated onto the substrate 116. A laser 160 may be focused directly on the ions 164 of the current collector material 162 at predetermined areas causing the ions 164 to react, cure, and form the desired pattern for the mesh current collector 126. The remaining ion 164 may then be rinsed off leaving the reacted ions 166 on the substrate, which is then annealed to form the mesh current collector 126. The non-reactive ions 164 can be rinsed off the substrate 116 using a solvent to dissolve the silver ion. It is appreciated that other methods of removing the non-reactive ions 164 can also be used.

FIG. 12 is a chart detailing materials and patterning process methods for manufacturing mesh current collectors.

### CONCLUSION

The foregoing description has broad application. For example, while examples disclosed herein may focus on discrete embodiments, it should be appreciated that the concepts disclosed herein may be combined together and implemented in a single structure. Additionally, although the various embodiments may be discussed with respect to current collectors in batteries for laptops and smartphones, the techniques and structures may be implemented in any type of electronic devices using thin film batteries. Accordingly, the discussion of any embodiment is meant only to be an example and is not intended to suggest that the scope of the disclosure, including the claims, is limited to these examples.

What is claimed is:

1. A battery core, comprising:
an anode layer;
an anode current collector adjacent the anode layer;
a cathode layer; and
a cathode current collector adjacent the cathode layer;
wherein at least one of the anode or cathode current collectors has a substantially mesh configuration.

2. The battery core of claim 1, wherein the at least one of the anode or cathode current collectors includes a network of strands arranged to form the substantially mesh configuration.

3. The battery core of claim 2, wherein the network of strands define a plurality of cells within the substantially mesh configuration.

4. The battery core of claim 3, wherein the plurality of cells have a generally square-shape.

5. The battery core of claim 3, wherein the plurality of cells have a generally hexagonal shape.

6. The battery core of claim 2, wherein the network of strands are arranged in a grid configuration.

7. The battery core of claim 1, wherein both the anode current collector and the cathode current collector have the substantially mesh configuration.

8. The battery core of claim 1, wherein:
the battery core has a stacked configuration, the anode layer being stacked directly above the anode current collector; and
the anode current collector has a substantially mesh configuration and a network of strands that define a plurality of cells within the substantially mesh configuration, the cells being configured to allow the transfer of ions between the anode layer and cathode layer.

9. The battery core of claim 1, wherein the cathode current collector is positioned below the cathode layer or the anode current collector is positioned above the anode layer.

10. The battery core of claim 1, further comprising an electrolyte layer between the anode layer and cathode layer.

11. A method of manufacturing a current collector for a battery core, comprising:
constructing a mold with at least one pattern of at least one substantially mesh configuration current collector;
coating a substrate with at least one resist material;
pressing the mold on the resist material; and
coating material for at least one current collector on at least one of the at least one resist material or the substrate.

12. The method of claim 11, further comprising cleaning at least one portion of the resist material to expose at least one portion of the substrate.

13. The method of claim 11, further comprising removing portions of the resist material that are not coated with the material for the at least one current collector.

14. The method of claim 13, wherein said operation of removing portions of the resist material that are not coated with the material for the at least one current collector further comprises at least one of interconnecting the portions of the resist material and peeling the interconnected portions of the resist material off the substrate, dissolving the portions of the resist material utilizing at least one solvent, heating the portions of the resist material, or illuminating a backside of the substrate.

15. The method of claim 11, wherein the mold includes at least one recess corresponding to a position of at least one strand of the at least one substantially mesh configuration current collector.

16. The method of claim 11, wherein the material comprises at least one metal.

17. A method of manufacturing a current collector for a battery core, comprising:
positioning a substrate under transferable material on a transparent support;
focusing a laser on the transparent support; and
releasing the transferable material from the transparent support in response to the laser; and
depositing the released transferable material on the substrate to form at least one substantially mesh configuration current collector.

18. The method of claim 17, wherein said operation of focusing a laser on the transparent support further comprises focusing a pulsed ultraviolet laser through a microscopic objective.

19. A method of manufacturing a current collector for a battery core, comprising:
coating a material on a substrate;
focusing a laser on ions of the material at predetermined areas to cause the ions to form at least one pattern of at least one substantially mesh configuration current collector; and
annealing the formed at least one pattern to form the at least one substantially mesh configured current collector.

20. The method of claim 19, rinsing non-reactive ions of the material off of the substrate utilizing at least one solvent.
